(19) United States
(12) Patent Application Publication
(10) Pub. No.: US 2026/0145451 A1
(43) Pub. Date: May 28, 2026

(54) Platen Belt with Cleaning Zones

(71) Applicant: Zebra Technologies Corporation, Lincolnshire, IL (US)

(72) Inventors: Richard J. Preliasco, North Kingstown, RI (US); David F. Beck, Exeter, RI (US)

(73) Assignee: Zebra Technologies Corporation, Lincolnshire, IL (US)

(21) Appl. No.: 18/962,457

(22) Filed: Nov. 27, 2024

(51) Int. Cl. B41J 29/17; B41J 11/02

(52) U.S. Cl. CPC B41J 29/17; B41J 11/02

(57) ABSTRACT

A printer is disclosed that includes a platen belt with a cleaning element that is configured to clean a printhead of the printer as the platen belt rotates.

### BACKGROUND

Media processing devices, or printers, were developed to allow a user to process media on-demand. Linerless type media is preferred in some instances by users, as the media does not have a backing web/liner applied and therefore results in less waste. However, issues arise in using linerless type media which includes, for example, the build-up of adhesive on internal components of the printer and the media sticking to components.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example media processing device in accordance with embodiments of the present disclosure.

FIG. 2 illustrates an interaction between a platen belt and a printhead of the example media processing device of FIG. 1 in which a cleaning element approaches the printhead in accordance with embodiments of the present disclosure.

FIG. 3 illustrates an interaction between the platen belt and the printhead of the example media processing device of FIG. 1 in which the cleaning element cleans the printhead in accordance with embodiments of the present disclosure.

FIG. 4 illustrates an interaction between the platen belt and the printhead of the example media processing device of FIG. 1 in which the cleaning element passes the printhead and another cleaning element approaches the printhead in accordance with embodiments of the present disclosure.

FIG. 5 illustrates an example platen belt in accordance with embodiments of the present disclosure.

FIG. 6 illustrates another example platen belt in accordance with embodiments of the present disclosure.

FIG. 7 illustrates another example platen belt in accordance with embodiments of the present disclosure.

FIG. 8 illustrates another example platen belt in accordance with embodiments of the present disclosure.

FIG. 9 illustrates another example platen belt in accordance with embodiments of the present disclosure.

FIG. 10 is a flowchart illustrating an example process of forming a platen belt in accordance with embodiments of the present disclosure.

FIG. 11 is a flowchart illustrating an example process of cleaning a printhead with cleaning elements of a platen belt in accordance with embodiments of the present disclosure.

FIG. 12 is a flowchart illustrating an example process of cleaning the cleaning elements of a platen belt in accordance with embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Embodiments of media processing devices of the present disclosure, such as printers, can process (e.g., print, encode, etc.) media by drawing the media from the media source and routing the media proximate various processing components (e.g., printhead, RFID reader/encoder, magnetic stripe reader/encoder etc.). Processing the media from the media source may facilitate a continuous or batch printing process. The processing of media by the media processing device can cause some residue build-up or other debris to accumulate on components of the media processing device (e.g., such as the printhead).

Some media may include a continuous web such as a spool of linerless media. The continuous web of linerless media is coated on one surface with a pressure sensitive adhesive and includes a printable surface on the opposite surface. For thermal transfer printing, the printable surface of the linerless media is configured to receive a pigment (e.g., ink, resin, wax-resin, etc.) that is transferred from a ribbon supply. For direct thermal printing, a thermal printhead of the printer directly contacts the printable surface triggering a chemical and/or physical change in a thermally sensitive dye covering and/or embedded in at least a portion of the printable surface of the media.

When the media is a linerless-type media, the side of the media including the adhesive is in contact with some of the components of the media processing devices, which may cause the adhesive to transfer to the components, causing the surface of the components to become sticky and adhere to media unintendedly. Those components, may in turn, be in contact with other components in the media processing device which can cause a transfer of the adhesive to components (e.g., such as the printhead) that are not in direct contact with the adhesive side of the linerless media.

For conventional media processing device that utilize a platen roller that comes in direct contact with the adhesive of the media, the adhesive can build up on the platen roller causing degrading performance of the platen roller and/or printhead over time and/or the adhesive can cause the media to stick to the platen roller such that the media wraps around the platen roller as the platen roller rotates. Further wear may be caused by the adhesive contacting the platen roller surface and forming mars in the surface.

Rather than utilizing a platen roller in direct contact with the media, embodiments of the present disclosure advantageously provide for a media processing device with a platen assembly that includes a belt, a portion of which comes into contact with the adhesive side of the media at any given time. As the belt can have a greater surface area than the platen roller, embodiments of the media processing device of the present disclosure can advantageously process more linerless-type media before the buildup of adhesive on the belt begins to cause issues. Embodiments of the belt can also advantageously include cleaning elements that are operable to clean the printhead, for example, as the cleaning elements travel past the printhead. Cleaning the printhead in this manner can remove residue build-up or other debris from the printhead and may aid in maintain a print quality of the printhead and may improve the lifespan of the printhead before the printhead needs to be replaced.

In accordance with embodiments of the present disclosure, a media processing device (e.g., a printer) is disclosed. The media processing device includes a printhead, a drive roller, and a platen belt. The platen belt is configured to be driven by the drive roller to rotate relative to the printhead. The platen belt has a media-facing surface that includes a cleaning element that is configured to contact at least a portion of the printhead as the platen belt rotates. The portion of the printhead is cleaned by the cleaning element.

In accordance with embodiments of the present disclosure, the media processing device further includes a media path configured to guide media from a media supply to the platen belt and the platen is configured to advance the media in a feed direction between the platen belt and the printhead in response to rotation of the platen belt such that when media is present between the printhead and the platen belt, the cleaning element ceases to clean the printhead.

In accordance with embodiments of the present disclosure, the cleaning element comes in contact with the media as the platen belt rotates and the media cleans the cleaning element.

In accordance with embodiments of the present disclosure, the cleaning element is integrated with the media-facing surface and is flush with the media-facing surface.

In accordance with embodiments of the present disclosure, the cleaning element protrudes from the media-facing surface.

In accordance with embodiments of the present disclosure, the cleaning element cleans pixels of the printhead.

In accordance with embodiments of the present disclosure, the media processing device further comprises a plurality of cleaning elements dispersed along the media-facing surface. The plurality of cleaning elements includes the cleaning element.

In accordance with embodiments of the present disclosure, the platen belt includes a first edge and a second edge and the media-facing surface has a width that extends from the first edge to the second edge. A length of the plurality of cleaning elements extends across the portion of the width between the first edge and the second edge.

In accordance with embodiments of the present disclosure, the plurality of cleaning elements extend between the first and second edges at an angle relative to an axis extending, perpendicularly to at least one of first edge or the second edge, along the media-facing surface.

In accordance with embodiments of the present disclosure, the angle is greater than zero degrees and less than ninety degrees.

In accordance with embodiments of the present disclosure, each of the plurality of cleaning elements have lengths that that are greater than the width of the media-facing surface.

In accordance with embodiments of the present disclosure, at least one of the plurality of cleaning elements form a V-shape having an internal angle that is greater than zero degrees and less than one hundred eighty degrees.

In accordance with embodiments of the present disclosure, the plurality of cleaning elements cover between one percent and thirty-five percent of a surface area of the media-facing surface.

In accordance with embodiments of the present disclosure, the cleaning element comprises microfiber cloth or ultra microfiber cloth composed of at least one of polyester, polyamide, acrylic, viscose, or polypropylene.

In accordance with embodiments of the present disclosure, a method of cleaning a printhead is disclosed. The method includes driving a drive roller via a motor operatively coupled to the drive roller and rotating a platen belt in response to the drive roller being driven via the motor. The platen belt includes a media-facing surface having a cleaning element. The method also includes cleaning at least a portion of the printhead with the cleaning element. The cleaning element comes in contact with the portion of the printhead as the platen belt rotates.

In accordance with embodiments of the present disclosure, the method includes guiding media from a media supply along a media path, advancing the media in a feed direction between the platen belt and the printhead in response to rotation of the platen belt, and cleaning the cleaning element with the media as the media advanced passed the printhead based on rotation of the platen belt.

In accordance with embodiments of the present disclosure, cleaning the cleaning element with the media comprises contacting an adhesive layer of the media with the cleaning element as the platen belt rotates.

In accordance with embodiments of the present disclosure, the cleaning element is integrated with the media-facing surface and is flush with the media-facing surface.

In accordance with embodiments of the present disclosure, cleaning the portion of the printhead comprises cleaning pixels of the printhead.

In accordance with embodiments of the present disclosure, a platen belt is disclosed. The platen belt includes an endless belt having a first edge and a second edge and a media-facing surface defining a first surface of the endless belt. The media-facing surface extends from the first edge to the second edge and comprises a first type of material having a first property that grips media to advance the media along a media path. The platen belt also includes an inner surface is disposed opposite the media-facing surface, where the inner surface extends from the first edge to the second edge. The platen belt also includes a cleaning element disposed on, or integrated with, the media-facing surface. The cleaning element comprises a second type of material different from the first type of material. The second type of material has a second property that cleans at least a portion of a printhead.

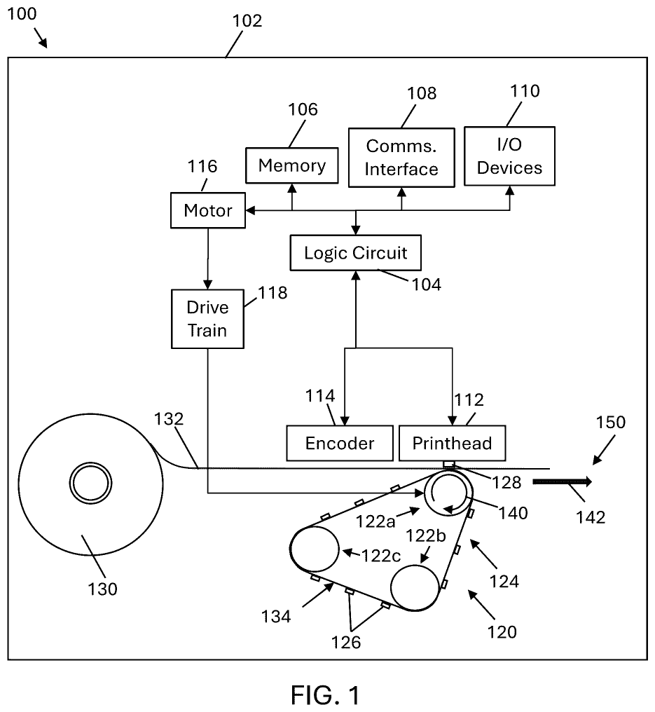

FIG. 1 illustrates a schematic diagram of an example media processing device 100, such as a printer, in accordance with embodiments of the present disclosure. The media processing device 100 can include a housing 102. The housing 102 contains or supports one or more components of the media processing device 100 including, for example, a logic circuit 104, memory 106, a communication interface 108 (e.g., for wired and wireless communication), input/output (I/O) devices 110 (e.g., a display, switches, buttons, speakers, microphone, etc.), a printhead 112, a radiofrequency encoder/reader 114, a motor 116, a drive train 118, and a platen assembly 120. The platen assembly 120 has rollers 122a-c and a platen belt 124 including cleaning elements 126. At least one of the rollers 122a-c can be a drive roller (e.g., roller 122a can be a drive roller). The platen belt 124 can be an endless belt that is driven by rotation of the drive roller 122a and can form a nip with the printhead 112. The housing 102 can also be configured to contain a media supply 130. As an example, the housing 102 can include a media chamber to store the media supply 130 as it is consumed by the media processing device 100. The logic circuit 104 can include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. The memory 106 is a non-transitory computer-readable medium that can include, for example, volatile (e.g., RAM, DRAM, SRAM, etc.) and/or non-volatile memory (e.g., ROM, PROM, EPROM, EEPROM, Flash memory device, optical memory device, magnetic memory device).

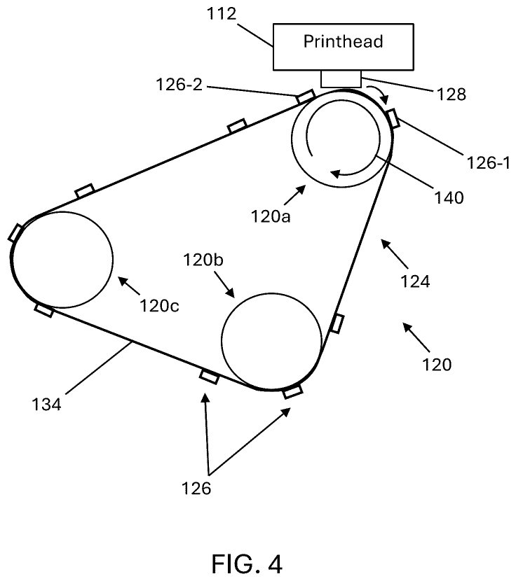

The logic circuit 104 of the media processing device 100 can be operatively coupled to the memory 106, the communications interface 108, the I/O devices 110, the printhead 112, the radiofrequency encoder/reader 114, and the motor 116. The drive roller 122a can be driven by the motor 116 via a drive train 118 to rotate the drive roller 122a about an axis of rotation in a first direction (e.g., clockwise in the orientation shown in FIG. 1 and denoted by arrow 140) and by extension can rotate the platen belt 124 in the first direction to pull the media 132 through the feed path in a direction indicated by arrow 142 and output the media 132 from the media processing device 100 via a media exit 150 formed in the housing 102 and can be driven by the motor 116 via the drive train 118 to rotate the drive roller 122a about the axis of rotation in a second direction (e.g., counterclockwise in the orientation shown in FIG. 4) and by extension can rotate the platen belt 124 in the second direction to retract the media 132 (in an opposite direction than the arrow 140). In one example, the logic circuit 104 can be configured to execute code stored in the memory 106 to perform operations and functions of the media processing device 100, e.g., by communicating with and/or controlling one or more of the components of the media processing device 100. The logic circuit 104 can execute the code stored memory 106 to implement a printing operation or function that controls the motor 116 to rotate the drive roller 122a to cause the platen belt 124 to feed the media 132 past the printhead 112, controls the printhead 112 to print on the media 132 (either directly or by transferring an ink from a ribbon to the media), and/or controls the RF encoder/reader 114 to encode and/or read radiofrequency circuits (e.g., RFID or NFC tags or inlays) included in or on the media 132. The printhead 112 of the media processing device 100 can selectively heat the printable surface of the media 132 triggering a chemical or physical change in a thermally sensitive dye covering at least a portion of the printable surface of the media 132. After printing on the media 132, the media can be further advanced and output from media processing device 100 by the operation of the platen belt 124.

The printhead 112 can have a burn line defined by a linear array of pixels 128 (also referred to as dots or burn elements). The linear array of pixels 128 in a direction perpendicularly to the feed direction 142 and across the media path. During printing operations, the pixels 128 can be selectively energized causing the temperature of the energized pixels to increase to a print temperature. The pixels 128 can contact the media 132 as it is processed along the media path in the feed direction and when no media is present the pixels 128 can come in contact with the platen belt 124. In one example, the printhead 112 and/or the pixels 128 are formed by a ceramic.

The platen belt 124 can include a media-facing surface 134 (or outer surface 134). The media-facing surface 134 can be composed of a first type of material that has a first property that grips the media 132 (e.g., prevents the media from slipping relative to the platen belt 124) to advance the media along a media path when the platen belt 124 rotates. The first property of the first type of material can be a static coefficient of friction, and the media-facing surface 134 can have a high static coefficient of friction, e.g., that is greater than 0.6, equal to or greater than 1, between 0.6 and 1, or between 1 and 1.5. As one example, the media-facing surface 134 can be composed of a polyurethane, silicone rubber, or a (synthetic or natural) rubber. The cleaning elements 126 can be distributed along the media-facing surface 134 of the platen belt 124. The cleaning elements 126 can be composed of a second type of material different from the first type of material. The second type of material can have a second property that cleans printhead or portion thereof. The second property of the second type of material can be a static coefficient of friction, and the cleaning elements 126 (when dry) can have a static coefficient of friction that is less than the static coefficient of the media-facing surface. As an example, the statis coefficient of friction of the cleaning elements can be equal to or less than 0.6 or between 0.3 and 6. As one example, the cleaning elements 126 can be formed by microfiber or ultra-mircofiber cloths, e.g., composed of polyester, polyamide (such as nylon), acrylic, viscose, polypropylene, or a combination thereof. The microfiber cloth can have fibers that are equal to or less than 1 decitex (1 decitex=1 g/10000 m). The ultra-microfiber cloth can have fibers that are equal to or less than 0.34 decitex. In one example, the cleaning elements 126 can be defined as strips disposed on or integrated with the media-facing surface 134 of the platen belt 124. The strips or an aggregation of the strips forming the cleaning elements 126 can extend across a width of the belt 124 and can engage the pixels 128 of the printhead 112 across a width of the burn line of the printhead 112 (e.g., a width of the linear array of pixels 128). In one example, the cleaning elements 126 can be flush with the media-facing surface 134 of the platen belt 124. In one example, the cleaning elements can be slight raised or can slightly protrude from the media-facing surface 132 of the platen belt 124. In one example, the cleaning elements 126 cover between one percent (1%) and thirty-five percent (35%) of a surface area of the media-facing surface 134 of the platen belt. The percentage or ratio of the surface area of the cleaning elements 126 to the media-facing surface 134 of the platen 124 can be specified such that the cleaning elements 126 do not affect the lifetime of the platen belt 124 (e.g., the platen belt 124 can have the same or similar life expectancy as a platen belt 124 that does not include cleaning elements 126).

The cleaning elements 126 can operate to clean the printhead 112 (e.g., the pixels 128 of the printhead 112) when no media 132 is present between the printhead 112 and the platen belt 124. As an example, the media can be removed by a user and the media processing device 100 can be operated to rotate the platen belt 124 to clean the printhead 112 (e.g., the pixels 128). As another example, when the media supply 130 is depleted such that no media 132 is present between the printhead 112 and the platen belt 124, the media processing device 100 can continue to drive the platen belt 124 to rotate (e.g., the motor 116 can be controlled by the logic circuit 104 to drive the drive roller 122a to rotate the platen belt 124) to automatically clean the printhead 112 (e.g., the pixels 128).

As described herein, the media supply 130 can include linerless media 132 having an exposed adhesive layer that comes into contact with the platen belt 124. In some examples, when media 132 is being processed by the media processing device 100, such that the media 132 passes between the printhead 112 and the platen belt 124, the adhesive on the media 132 can clean the cleaning elements, e.g., debris or residue build-up on the cleaning elements 126 (e.g., from cleaning the printhead 112) can be removed by the adhesive of the media 132 as the media 132 engages and disengages the platen belt 124. Using this approach, a cleaning cycle can be formed in which the cleaning elements 126 can clean the printhead 112 and the media 132 can clean the cleaning elements 126 removing the debris or residue build-up from the media processing device 100.

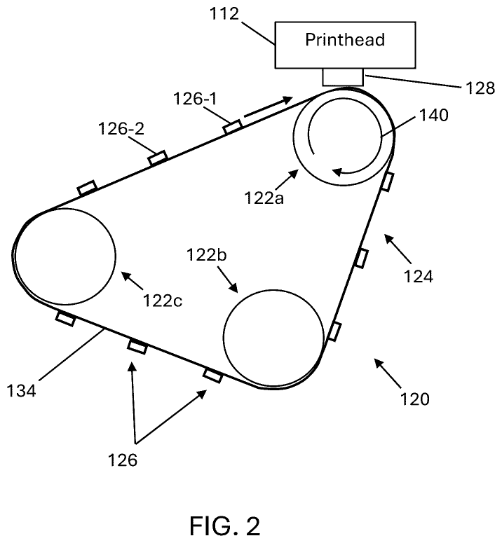

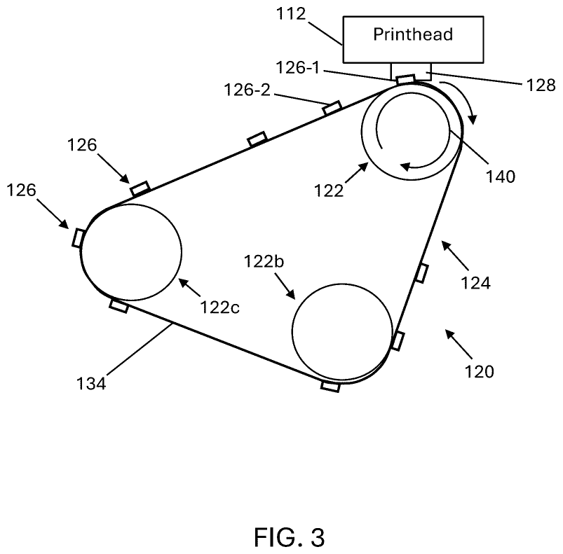

FIGS. 2-4 illustrate an example operation of the cleaning elements 126 of the platen belt 124 when no media is present in accordance with embodiments of the present disclosure. As shown in FIGS. 2-4 the drive roller 122a can drive the platen belt 124 to rotate in the first direction. As the platen belt 124 rotates the cleaning elements 126 pass by and come in contact with the printhead 112 (e.g., with the pixels 128 of the printhead 112) to clean the printhead 112 (or the pixels 128 of the printhead 112), e.g., by wiping and/or brushing the printhead 112 or pixels 128 of the printhead 112. As an example, following one of the cleaning elements 126-1 as the platen belt 124 rotates. The cleaning element 126-1 is positioned upstream of the printhead 112 as shown in FIG. 2. As the platen belt 124 rotates, the cleaning element 126-1 (moving in the feed direction) comes in contact with the printhead 112 (or the pixels 128 of the printhead 112), as shown in FIG. 3, to clean the printhead 112. As the platen belt 124 continues to rotate, the cleaning element 126-1 passes by the printhead 112 to a position that is downstream of the printhead 112 and a next one of the cleaning elements 126-2 is positioned to clean the printhead as the platen belt 124 continues to rotate, as shown in FIG. 4.

In some embodiments, the platen belt 124 can be driven to rotate in the second direction such that the cleaning elements 126 pass by and cleaning the printhead 112 in a direction that is opposite of the feed direction 142. For example, the cleaning element 126-1 can be positioned downstream of the printhead 112, as shown in FIG. 4, and the platen belt 124 can rotate in the second direction such that the cleaning element 126-1 comes in contact with the printhead 112 (or the pixels 128 of the printhead 112), as shown in FIG. 3, to clean the printhead 112. The platen belt 124 can continue to rotate in the second direction such that the cleaning element 126-1 passes by the printhead 112 to a position that is upstream of the printhead 112, as shown in FIG. 2.

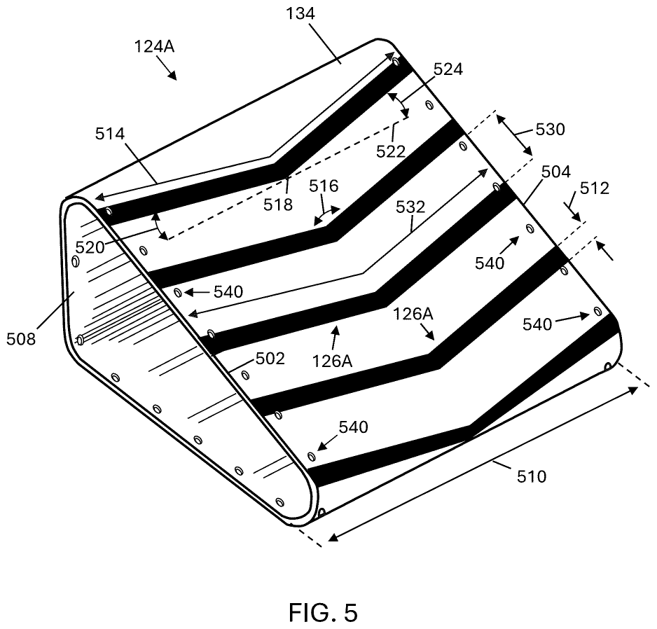

FIG. 5 illustrates an example platen belt 124A in accordance with embodiments of the present disclosure. The platen belt 124A can be an endless belt having a first edge 502 and a second edge 504. The media-facing surface 134 and an inner surface 508 are opposingly spaced from each other and extend from the first edge 502 to the second edge 504. A thickness of the platen belt 124A separates the media-facing surface 134 from the inner surface 508. The platen belt 124A (and the media-facing surface 134 and the inner surface 508) can have a width 510 measured between, and perpendicular to, the edges 502 and/or 504. The width 510 can be equal to or greater than the width of the linear array of pixels 128 of the printhead 112 (e.g., FIGS. 1-4).

Cleaning elements 126A can extend across a portion or an entirety of the width 510 of the media-facing surface 134 and can have different geometries and dimensions. The cleaning elements 126A can have a width 512 and a length 514 defining a surface area of the cleaning elements 126A. In the present example, the cleaning elements 126A can be rectilinear structures where the width 512 of the cleaning elements 126A are generally uniform along the length 514 of the cleaning elements 126A. In some examples the length 514 of the cleaning elements 126A can be less than, equal to, or greater than the width 510 of the platen belt 124A. As an example, the example cleaning elements 126A illustrated in FIG. 5 can have a length that is greater than the width 510 of the platen belt 124A.

The cleaning elements 126A can be spaced away from each other along the media-facing surface 134 by a specified distance to intersperse the cleaning elements 126A with the media-facing surface 134 (e.g., such that alternating pattern of the media-facing surface 134 and the cleaning elements 126A is formed about the platen belt 124A). Portions of the media-facing surface 134 adjacent to the cleaning elements 126A can have widths 530 and lengths 532 defining a surface area of the portions of the media-facing surface 134 between the cleaning elements 126A. In one example, the length 532 of the portions of the media-facing surface 134 between the cleaning elements 126A can be equal to the length 514 of the cleaning elements 126A and the width 530 of the portions of the media-facing surface 134 between the cleaning elements 126A can be greater than the width 512 of the cleaning elements 126A. In one example, the width 530 can be at least two times the width 512 and/or the surface area of the portions of media-facing surface 134 between the cleaning elements 126A can be at least two times the surface area of the cleaning elements 126A. In one example, the aggregated surface area of the cleaning elements 126A can be between one percent (1%) and thirty-five (35%) of the total surface area including the portions of the media-facing surface 134 and the cleaning elements 126A.

The example cleaning elements illustrated in FIG. 5 have V-shaped geometries with a vertex of the V-shaped geometry being positioned at or near a mid-point between the first edge 503 and the second edge 504. An interior angle 516 of the cleaning elements 126A can be an obtuse angle. As an example, the interior angle 516 of the cleaning elements 126A can be equal to or greater than one hundred forty-five (145) degrees and less than one hundred eighty (180) degrees. As another example, the cleaning elements 126A can include a first portion that extend from the first edge 502 to an intermediate point 518 (e.g., the midpoint or near the midpoint) at a first angle 520 relative to an axis 522 extending along the media-facing surface 134 perpendicular to the edges 502 and/or 504 and can extend from the intermediate point 518 to the second edge 504 at a second angle 524 relative to the axis 522. In one example the angles 520 and 524 can be equal to each other. In one example, the angles 520 and/or 524 can be greater than zero (0) degrees, can be greater than zero (0) degrees and less than ninety (90) degrees, or can be greater than zero (0) degrees and less than fifty (50) degrees. In one example, the angles 520 and 524 can be different from each other. In one example, at least one of the angles 520 or 524 can be zero degrees. In some examples, the friction generated between the media-facing surface 134 and the media can be greater than the friction generated between the cleaning elements 126A and the media such that the media is less likely to slip when the media contacts the media-facing surface 134 and more likely to slip when the media contacts the cleaning elements 126A. To eliminate or mitigate slippage of the media as it is processed by the media processing device, the angles 516, 520, and/or 524 at which the cleaning elements 126A extend and/or the spacing between the cleaning elements 126A can be specified so that media (e.g., the media 132 shown in FIG. 1) contacts a specified amount of the media-facing surface 134 across the width 510 as the platen belt 124A rotates. As one example, the cleaning elements 126A can be defined such that a width of the media contacts between sixty-five (65%) and hundred percent (100%) of the media-facing surface 134.

In some examples, the drive roller 122a shown in FIGS. 1-4 can be a pin drive that including pins that engage the platen belt 124A. To facilitate engagement with such a pin drive, the platen belt 124A can include holes 540 distributed along the edges 502 and 504 of the platen belt 124A. In some examples, the platen belt 124A can be devoid of the holes 540.

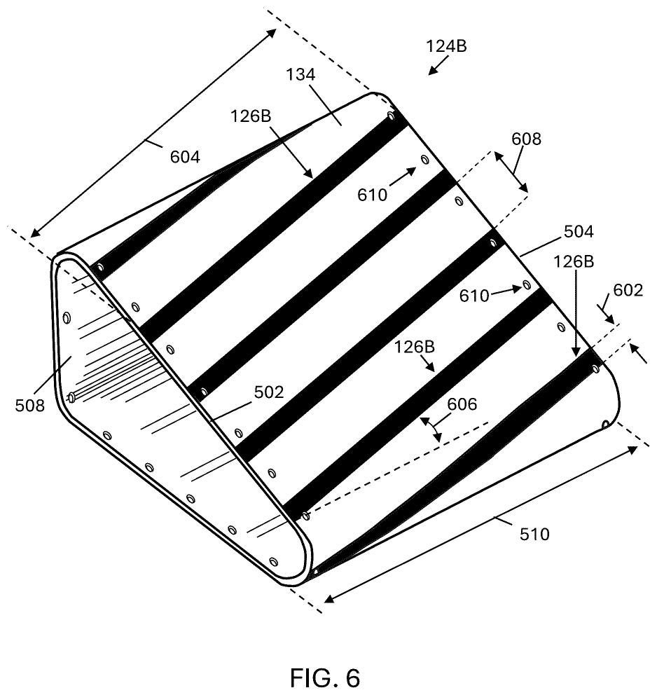

FIG. 6 illustrates another example platen belt 124B in accordance with embodiments of the present disclosure. Generally speaking, the structure of the platen belt 124B is similar in construction to the platen belt 124A. Except where noted herein, the description of the platen belt 124A and the components, properties, and features thereof, apply to the platen belt 124B and for the sake of brevity will not be repeated. As shown in FIG. 6, the platen belt 124B can include cleaning elements 126B having rectilinear structures that extend linearly across the width 510 of the media-facing surface 134. The cleaning elements 126B can extend across a portion or an entirety of the width 510 of the media-facing surface 134. The width 512 and length 514 of the cleaning elements 126B can define a surface area of the cleaning elements 126B. In the present example, the cleaning elements 126B can extend linearly from the first edge 502 to the second edge at an angle 620 relative to the axis 522 extending along the media-facing surface 134 perpendicular to the edges 502 and/or 504. In one example the angle 620 can be zero (0) degrees, can be greater than zero (0) degrees and less than ninety (90) degrees, or can be greater than zero degrees and less than fifty (50) degrees. In some examples, the friction generated between the media-facing surface 134 and the media can be greater than the friction generated between the cleaning elements 126B and the media such that the media is less likely to slip when the media contacts the media-facing surface 134 and more likely to slip when the media contacts the cleaning elements 126B. To eliminate or mitigate slippage of the media as it is processed by the media processing device, the angle 620 at which the cleaning elements 126B extend and/or the spacing between the cleaning elements 126B can be specified so that media (e.g., the media 132 shown in FIG. 1) contacts a specified amount of the media-facing surface 134 across the width 510 as the platen belt 124A rotates. As one example, the cleaning elements 126A can be defined such that a width of the media contacts between sixty-five (65%) and hundred percent (100%) of the media-facing surface 134.

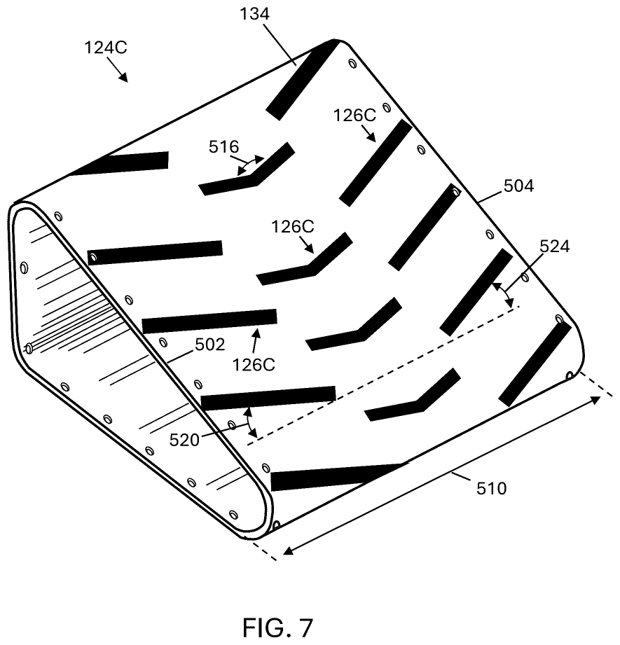

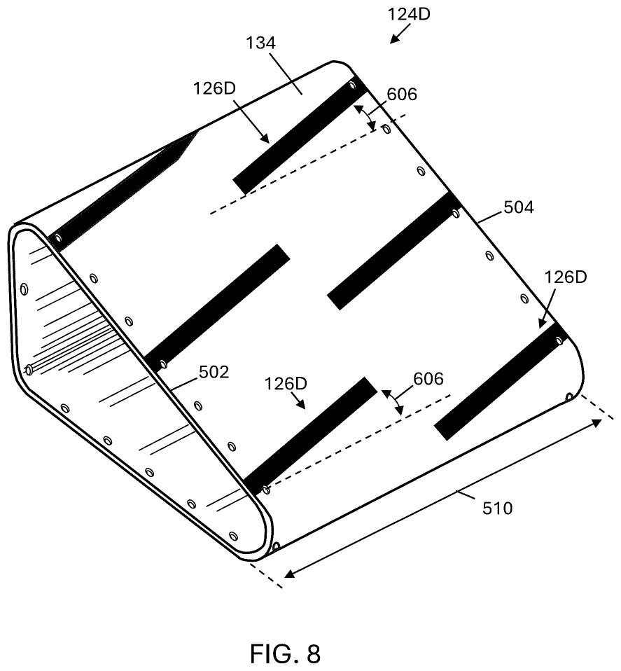

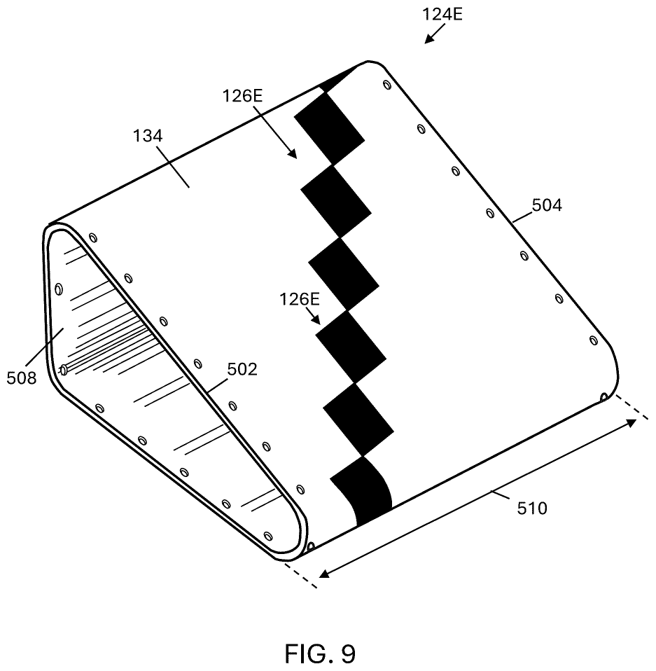

While example embodiments of the platen belt 124 (e.g., platen belts 124A-B) have been illustrated with embodiments of cleaning elements 126 (e.g., cleaning elements 126A-B), exemplary embodiments can include cleaning elements 126 with different geometries and dimensions. As an example, the cleaning elements 126 can be segmented and offset across the width 510 of the media-facing surface 134, e.g., such as example cleaning elements 126C of an example platen belt 124C shown in FIG. 7 in which the plurality of cleaning elements 126C extend inward from each edge 502 and 504 and terminate at an intermediate point along the width 510 (e.g., at or near a midpoint), example cleaning elements 126D of an example platen belt 124D shown in FIG. 8 in which some cleaning elements 126D extend inward from each edge 502 and 504 and terminate at different intermediate point and some cleaning elements 126D have a V-shape and extend between the different intermediate points, and example cleaning elements 126E of an example platen belt 124E shown in FIG. 9 in which the cleaning elements have lengths that extend parallel to the edges 502 and/or 504 and are offset along the width 510. The platen belts 124C-E are each similar in construction to the platen belts 124A and 124B, except as noted herein, such that the description of the platen belts 124A and 124B and the components, properties, and features thereof, apply to the platen belts 124C-E and for the sake of brevity will not be repeated. Additionally, while example embodiments of the platen belts 124 have been illustrated with a quantity and a spacing of the cleaning elements 126 along the media-facing surface 134, exemplary embodiments of the platen belt can include more or fewer cleaning elements 126 that are spaced farther apart or closer to each other.

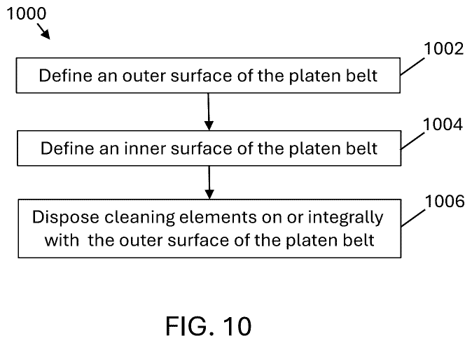

FIG. 10 is a flowchart illustrating an example process 1000 for forming a platen belt (e.g., platen belt 124 or any one of platen belts 124A-E) in accordance with embodiments of the present disclosure. At operation 1002, an outer surface (e.g., media-facing surface or outer surface 132) is defined on a first surface of an endless belt. The outer surface extends from a first edge (e.g., edge 502) to a second edge (e.g., edge 504) of the endless belt. The outer surface is composed of a first type of material that has a first property (e.g., a high static coefficient of friction) that grips media (e.g., media 132) to advance the media along a media path. At operation 1004, an inner surface (e.g., inner surface 508) is defined opposite the outer surface and extends from the first edge to the second edge. At operation 1006, cleaning elements (e.g., cleaning element 126 or any one of cleaning elements 164A-E) are disposed on, or integrated with, the outer surface. The cleaning elements comprise a second type of material different from the first type of material (e.g., a static coefficient that is less than the static coefficient of the first type of material). The second type of material has a second property that cleans at least a portion of a printhead (e.g., microfibers or ultra-microfibers).

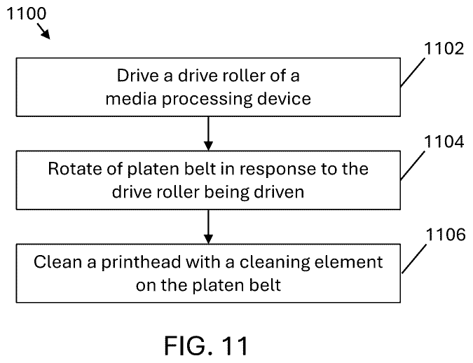

FIG. 11 is a flowchart illustrating an example process 1100 for cleaning a printhead in accordance with embodiments of the present disclosure. At operation 1102, a drive roller (e.g., drive roller 122a) of a media processing device (e.g., media processing device 100) is driven via a motor (e.g., motor 116) operatively coupled to the drive roller. At operation 1104, a platen belt (e.g., platen belt 124 or any one of platen belts 124A-E) rotates in response to the drive roller being driven via the motor. The platen belt including a media-facing surface (e.g., media-facing surface 134) having cleaning elements (e.g., cleaning elements 126 or any one of cleaning elements 126A-E). At operation 1106, at least a portion of the printhead is cleaned with the cleaning element. The cleaning element coming in contact with the at least a portion of the printhead as the platen belt rotates.

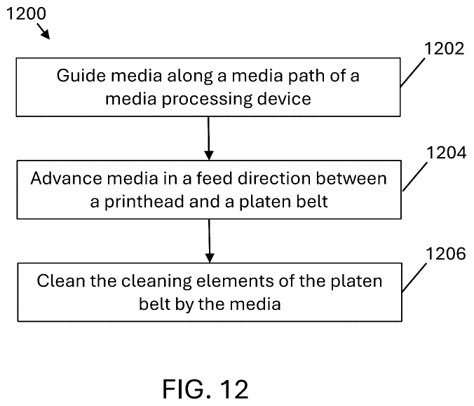

FIG. 12 is flowchart illustrating an example process 1200 for cleaning the cleaning elements (e.g., cleaning elements 126 or any one of cleaning elements 126A-E) of a platen belt (e.g., platen belt 124 or any one of platen belts 124A-E) in accordance with embodiments of the present disclosure. At operation 1202, media (e.g., media 132) is guided from a media supply (e.g., media supply 130) along a media path of a media processing device (e.g., media processing device 100). At operation 1204, the media is advanced in a feed direction (or a direction opposite the feed direction) between the platen belt and the printhead in response to rotation of the platen belt. At operation 1206, the cleaning elements are cleaned by the media as the media passes (e.g., advances or retracts) a printhead (e.g., printhead 112) based on rotation of the platen belt.

The above description refers to diagrams of the accompanying drawings. Alternative implementations of the example represented by the diagrams include one or more additional or alternative elements, processes and/or devices. Additionally, or alternatively, one or more of the example elements of the diagram may be combined, divided, re-arranged or omitted.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A printer comprising:
a printhead;
a drive roller; and
a platen belt configured to be driven by the drive roller to rotate relative to the printhead, the platen belt having a media-facing surface that includes a cleaning element, the cleaning element configured to contact at least a portion of the printhead as the platen belt rotates, the portion of the printhead being cleaned by the cleaning element.

2. The printer of claim 1, further comprising:
a media path configured to guide media from a media supply to the platen belt and the platen is configured to advance the media in a feed direction between the platen belt and the printhead in response to rotation of the platen belt such that when media is present between the printhead and the platen belt, the cleaning element ceases to clean the printhead.

3. The printer of claim 2, wherein the cleaning element comes in contact with the media as the platen belt rotates and the media cleans the cleaning element.

4. The printer of claim 1, wherein the cleaning element is integrated with the media-facing surface and is flush with the media-facing surface.

5. The printer of claim 1, wherein the cleaning element protrudes from the media-facing surface.

6. The printer of claim 1, wherein the cleaning element cleans pixels of the printhead.

7. The printer of claim 1, further comprising:
a plurality of cleaning elements dispersed along the media-facing surface, the plurality of cleaning elements includes the cleaning element.

8. The printer of claim 7, wherein the platen belt includes a first edge and a second edge and the media-facing surface has a width that extends from the first edge to the second edge, a length of the plurality of cleaning elements extends across the portion of the width between the first edge and the second edge.

9. The printer of claim 8, wherein the plurality of cleaning elements extend between the first and second edges at an angle relative to an axis extending, perpendicularly to at least one of first edge or the second edge, along the media-facing surface.

10. The printer of claim 9, wherein the angle is greater than zero degrees and less than ninety degrees.

11. The printer of claim 10, wherein each of the plurality of cleaning elements have lengths that that are greater than the width of the media-facing surface.

12. The printer of claim 7, wherein at least one of the plurality of cleaning elements form a V-shape having an internal angle that is greater than zero degrees and less than one hundred eighty degrees.

13. The printer of claim 7, wherein the plurality of cleaning elements cover between one percent and thirty-five percent of a surface area of the media-facing surface.

14. The printer of claim 1, wherein the cleaning element comprises microfiber cloth or ultra microfiber cloth composed of at least one of polyester, polyamide, acrylic, viscose, or polypropylene.

15. A method of cleaning a printhead comprising:
driving a drive roller via a motor operatively coupled to the drive roller;
rotating a platen belt in response to the drive roller being driven via the motor, the platen belt including a media-facing surface having a cleaning element; and
cleaning at least a portion of the printhead with the cleaning element, the cleaning element coming in contact with the portion of the printhead as the platen belt rotates.

16. The method of claim 15, further comprising:
guiding media from a media supply along a media path;
advancing the media in a feed direction between the platen belt and the printhead in response to rotation of the platen belt; and
cleaning the cleaning element with the media as the media advanced passed the printhead based on rotation of the platen belt.

17. The method of claim 16, wherein cleaning the cleaning element with the media comprises:
contacting an adhesive layer of the media with the cleaning element as the platen belt rotates.

18. The method of claim 15, wherein the cleaning element is integrated with the media-facing surface and is flush with the media-facing surface.

19. The method of claim 15, wherein cleaning the portion of the printhead comprises:
cleaning pixels of the printhead.

20. A platen belt, comprising:
an endless belt having a first edge and a second edge;
a media-facing surface defining a first surface of the endless belt, the media-facing surface extending from the first edge to the second edge, the media-facing surface comprises a first type of material having a first property that grips media to advance the media along a media path;
an inner surface is disposed opposite the media-facing surface and extends from the first edge to the second edge; and
a cleaning element disposed on, or integrated with, the media-facing surface, the cleaning element comprises a second type of material different from the first type of material, the second type of material having a second property that cleans at least a portion of a printhead.
